(19) United States
(12) Patent Application Publication
(10) Pub. No.: US 2026/0149332 A1
(43) Pub. Date: May 28, 2026

(54) MowGen Portable Generator Attachment for Riding Lawn Tractors

(71) Applicant: Anthony Patrick Giunta, Lake Wales, FL (US)

(72) Inventor: Anthony Patrick Giunta, Lake Wales, FL (US)

(21) Appl. No.: 18/831,872

(22) Filed: Oct. 20, 2025

Related U.S. Application Data
(60) Provisional application No. 63/833,123, filed on Oct. 25, 2024.

(51) Int. Cl. H02K 7/18; A01D 69/00; A01D 101/00; H02K 7/10

(52) U.S. Cl. CPC H02K 7/1815; A01D 69/002; H02K 7/1004; A01D 2101/00

(57) ABSTRACT

MowGen is a generator apparatus designed for integration with riding mower power take-off systems, providing a mobile and immediately reliable electrical power source. MowGen comprises a mounting assembly with lift-link hangers and mounting flanges, a power transmission system including a PTO pulley interface, generator pulley stack, belt, and tensioner/activation arm, and a power distribution system featuring a breaker panel, outlet array, status indicator row, and transfer-switch interface. MowGen further includes a housing, swivel casters, and dual maneuver handles for enhanced mobility. MowGen addresses issues of fuel degradation, generator transport complexity, and electrical interfacing by leveraging the frequent use and mobility of riding mowers, enabling efficient and flexible backup or remote power generation.

### CROSS-REFERENCE TO RELATED APPLICATIONS

This application claims the benefit of U.S. Provisional Patent Application No. 63/833,123, filed Oct. 25, 2024, entitled “Mower-Gen,” the entire disclosure of which is hereby incorporated by reference.

### BACKGROUND

Gasoline backup generators that are often times used infrequently are susceptible to fuel degradation and internal metal corrosion, which can result in unreliable operation and start-up failures. Traditional portable generators often remain idle for extended periods, leading to stale fuel, clogged carburetors, and compromised engine performance. Prior attempts to address these issues have included the use of fuel stabilizers and periodic maintenance schedules; however, such measures are often plagued with ineffective stabilizer products and are often neglected by users, resulting in persistent reliability problems when backup power is needed most.

The transportation and positioning of standalone generators present additional challenges. Conventional portable generators are typically heavy and cumbersome, requiring significant manual effort to move and set up at the desired location. Users must often lift, wheel, or otherwise maneuver these units over uneven terrain or through narrow spaces, which can be physically demanding and time-consuming. Existing solutions have not adequately reduced the complexity or labor associated with deploying portable generators in residential or outdoor environments.

Existing emergency home generator solutions generally do not provide integration with riding mower power take-off (PTO) systems. While riding mowers are commonly available in residential and commercial settings, prior art has not leveraged the mechanical power output of these ubiquitous machines to drive electrical generators. As a result, users must rely on separate, dedicated generator units which increases equipment redundancy and storage requirements.

There is also a need for a mobile power source that offers immediate reliability, particularly in situations where the host vehicle or equipment is used frequently.

Traditional portable generators, due to their infrequent use, are prone to mechanical and fuel-related issues that compromise readiness. Prior art has not provided a solution that ensures a power source remains in a reliable operational state through regular use of a host vehicle, such as a riding mower, thereby limiting and sacrificing the dependability of backup power in critical situations.

### SUMMARY

MowGen is a modular generator system designed to integrate with riding mowers by utilizing the mower's power take-off (PTO) system to generate electrical power for residential, commercial, and tractor transported mobile use. MowGen comprises a common mounting assembly, a power transmission system, a rotor-stator assembly, a voltage regulator, and a power distribution system housed within a weather-sealed enclosure. MowGen incorporates a range of variants, including a hand activated PTO-clutch arm, double-sided power-access, and smart monitoring and control, to provide enhanced adaptability, serviceability, and operational reliability. MowGen's design enables rapid attachment to and detachment from a host riding lawn mower, facilitating both stationery and mobile power generation with minimal user knowledge of mechanical systems or physical effort.

MowGen addresses the problem of fuel degradation and start-up failures of infrequently used gasoline backup generators by leveraging the riding mower's engine, which is typically maintained and operated regularly. The mounting assembly that essentially duplicates the mounting assembly of a mower deck and power transmission system enables MowGen to be powered by the mower's PTO, eliminating the need for a dedicated generator engine that would otherwise be susceptible to fuel-related and other low use long storage fuel delivery system issues. This approach ensures that the generator system remains immediately operational whenever the mower is functional, thereby improving reliability compared to conventional standalone generators.

MowGen solves the complexity and effort required to transport and position standalone generators by integrating adjustable swivel casters, a dual-sided maneuver handle, all attached to a lightweight composite body. The mounting assembly allows for rapid installation and removal from the host vehicle, while the composite body with integrated swivel casters facilitate easy movement and positioning. These features collectively reduce the physical effort and time required to deploy the generator, representing a significant improvement over prior art that relies on heavy cumbersome standalone units. MowGen provides an integrated generator solution that leverages existing riding mower PTO systems, addressing the lack of such solutions in prior art. The power transmission system comprised of the existing lawn tractor vertical engine PTO pulley interface, generator pulley stack, belt, and tensioner/activation arm, is specifically engineered to couple with a wide range of industry standard mower PTO configurations. This industry standard integration enables users to convert a common riding mower into a reliable generator platform without the need for extensive modifications or additional engines. MowGen addresses the difficulty of interfacing small engine power outputs with home or business electrical panels through the power distribution system, which includes a breaker panel, outlet array with 120 V duplex outlets, 30-ampere twist-lock outlets, and 50-ampere split-phase connectors, as well as a transfer-switch interface. The integrated transfer-switch variant and status indicator row provide safe, code-compliant, and user-friendly connections to home or business electrical system.

MowGen fulfills the need for a mobile power source that is immediately reliable due to frequent use of the host riding mower by combining the mounting assembly, power transmission system, and power distribution system into a single, easily deployable unit. The frequent operation and maintenance of the host mower ensure that the generator system remains in a ready state, providing a dependable source of power whenever and wherever needed which is a substantial improvement over traditional backup generators that may suffer from neglect, unreliability, and difficult transportability.

### BRIEF DESCRIPTION OF THE FIGURES

FIG. 1—MowGen mounted to a standard riding mower in operation

FIG. 2—Front and back views of MowGen unit

FIG. 3—Left and right side views of MowGen

FIG. 4—Step sequence for engaging MowGen

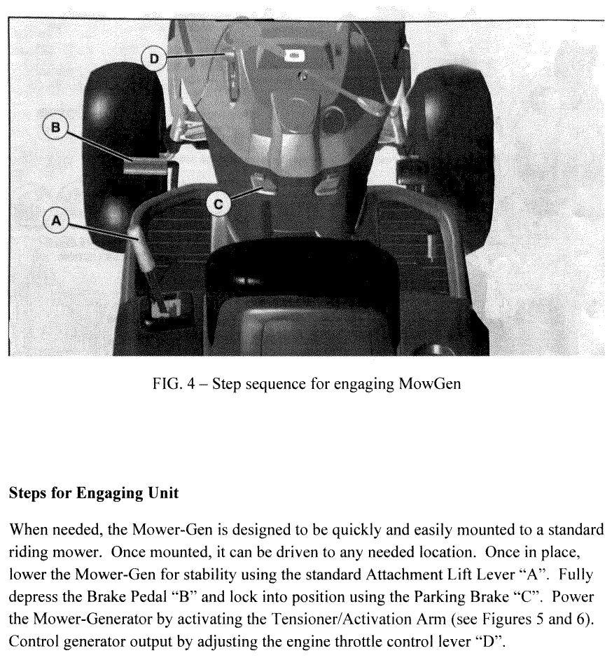

FIG. 5—Top view of MowGen showing pulley layout

FIG. 6—Component identification, top view

FIG. 7—Structure and swivel wheels of MowGen

FIG. 8—Right-side power outlet and connector layout

FIG. 9—Left-side power outlet and connector layout

### DETAILED DESCRIPTION

### MowGen

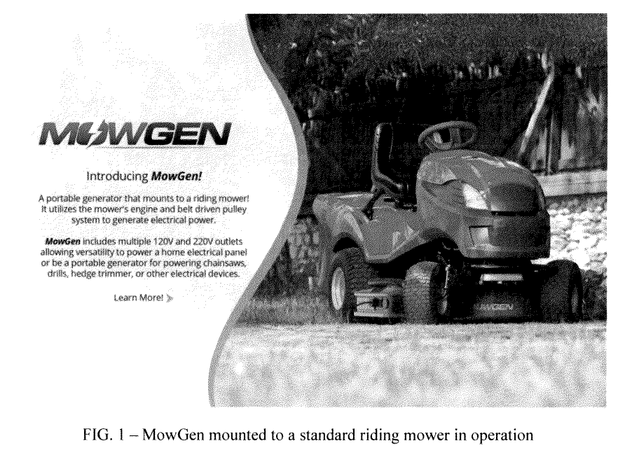

As shown in FIG. 1, the MowGen can provide a modular generator assembly that mounts beneath a riding lawn tractor and interfaces with existing mower controls to deliver electrical power without adding a separate engine. Generally, the MowGen is an electrical generator whereby the generator (or generators) is powered by a belt-driven input shaft or shafts, and then power is distributed via a dual-sided power distribution panel while preserving the transportability via ground clearance controlled by the lift-handle capabilities of a typical lawn tractor. More specifically, the MowGen can interface with a tractor power take-off via a V-belt and pulley arrangement so that the tractor engine drives a rotor-stator assembly, while the MowGen can route resulting electrical output to onboard receptacles. In particular, the MowGen can utilize existing lift linkage and deck attachment points so that a user can swap out a common mower deck and directly replace it with the MowGen generator unit using three common connector points (one aft, two rear). Upon routing the V-belt, the unit utilizes the mower's existing PTO to produce power by activating a pivoting tensioner/activation arm so that the user selectively couples or decouples the mower's belt drive without any modifications needed to the typical belt drive system of the tractor. Additionally, MowGen allows dual-sided electrical output panels that provide multiple 120-volt and 120/240-volt receptacles protected by a breaker panel. MowGen offers convenient outlets on opposing housing sides to facilitate cable access in varied parking orientations and field situations. Also, MowGen can be easily maneuvered to mount under the tractor or remove to be stored by utilizing its permanently mounted swivel caster wheels and dual-sided handles. MowGen leverages the tractor's normal engine operating horsepower output and throttle control to maintain generator output while the MowGen maintains activation through the PTO so that no additional operator interface becomes necessary. MowGen can deliver power through onboard outlets and extension cords for a wide range of utility tools and appliances or can provide whole home/business power via a higher amperage connection cable suited for whole home power. Thus, the MowGen addresses typical standalone generator reliability and mobility challenges by both coupling the generator to the existing V-belt driven system of the existing lawn tractor and by allowing the nit to be easily installed on a four wheeled portable lawn tractor system. By doing so, Mow Gen leverages a frequently operated common lawn tractor engine that avoids fuel degradation by eliminating a separate infrequently used engine to provide reliable engine operation that powers tools, appliances, and whole home/business. By easily mounting to and utilizing the four wheeled transportation powertrain of a common riding lawn tractor, MowGen power is easily transported to and delivered via a outlet distribution interface to remote locations.

### Mounting Assembly

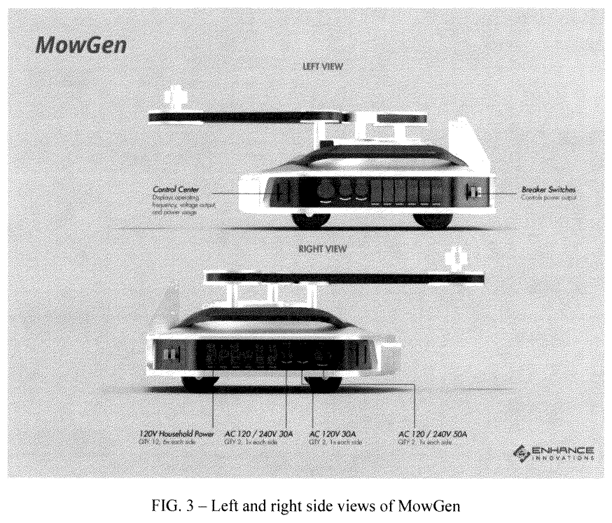

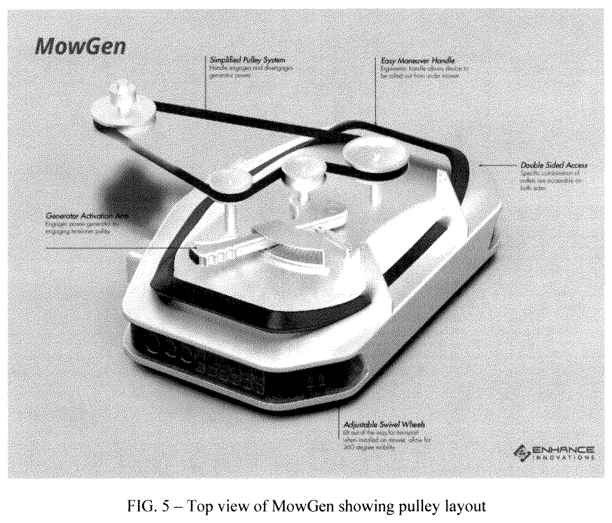

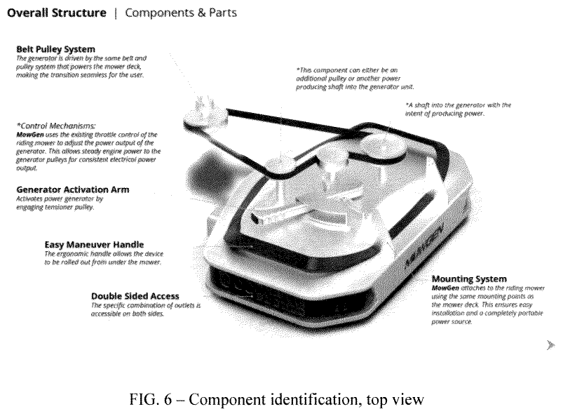

As shown in FIG. 3, FIG. 5, and FIG. 6, the mounting assembly provides a mechanical interface between the generator deck and the chassis of a riding lawn tractor by coupling to before and aft lift-link hangers/pins and by aligning with mounting flanges that mirror conventional mower deck geometry. The mounting assembly can position lateral mounting flanges that include transverse apertures dimensioned to receive aft lift rods and before deck-lift pins to enable direct substitution of MowGen to the tractor chassis without modification to the tractor frame or linkage geometry. The mounting assembly can engage lift-link hangers to register deck height, within tolerances of a normal mower deck that preserves belt alignment for a power transmission system. The generator housing connection links can maintain the generator deck in a level orientation whether suspension by a tractor lift mechanism occurs or when resting on the ground. The mounting assembly includes quick-release pins and/or a locking mechanism to enable tool-less installation and removal. The mounting assembly can locate the generator deck within a spatial envelope beneath the tractor chassis that corresponds to a mower deck envelope so that standard lift and lowering controls operate without any modifications. The mounting assembly includes swivel casters to provide maneuverability when detachment from the tractor occurs. The mounting assembly can withstand torsional and vibrational loads transmitted from a power take-off system by employing corrosion-resistant steel, coated aluminum, and/or other outdoor-rated structural materials. Thus, the mounting assembly addresses transport complexity and lack of integrated mower-based generator solutions by enabling direct substitution on existing lift hardware and by supporting immediate deployment with familiar lift and lowering tractor controls.

### Lift-Link Hangers

The lift-link hangers are intrinsic to any common riding mower and can mount to the MowGen housing as paired structural brackets and can position to interface with fore and aft lift links of a standard riding lawn tractor. The lift-link hangers can align a lateral aperture or slot with stock deck-lift pins and can accept the pins to secure attachment without modification to the tractor frame. The lift-link hangers can permit vertical adjustment of a generator deck position via a tractor lift lever mechanism and can allow an operator to raise or lower the mounting assembly for transport and/or operational stability. The lift-link hangers can define geometry and material selections that distribute static and dynamic loads encountered during over-the-road movement and stationary generator operation. The lift-link hangers can enable quick installation and removal to facilitate conversion between mowing and power generation functions. In one implementation, the lift-link hangers can incorporate bushings or wear-resistant inserts at a pivot interface to reduce friction and extend service life. Therefore, the lift-link hangers address the complexity and effort required to transport and position MowGen generator and support a need for a mobile power source that remains immediately reliable by enabling direct, tool-free attachment and repeatable lift control on a frequently used host vehicle.

### Mounting Flanges

As shown in FIG. 3, FIG. 5 and FIG. 6, the mounting flanges position vertically at the front mid-point and each corner of the housing and fasten to the generator deck enclosure to establish a load path that supports static suspension and dynamic operation. The mounting flanges incorporate laterally elongated slotted apertures that accept stock deck-lift link hangers and pins at linkage points of a typical riding mower chassis to quickly connect via quick connect pins, without any modifications to that standard riding mower. The mounting flanges align with industry-standard deck mounting patterns. The mounting flanges are either welded or are part of the resin outer shell of the MowGen unit. The mounting flanges cooperate with the mounting assembly by presenting corner datum faces that index to front stabilizing and rear lift-link hangers so that the power transmission system maintains pulley alignment during power take-off (PTO) engagement. The mounting flanges facilitate direct replacement of a mower deck with the MowGen generator deck. This eliminates any setup complexity by allowing a user to quickly connect and then lift the generator module with existing deck-lift geometry, which addresses transport and positioning challenges and leverages the frequently used mower platform for immediately reliable mobile power without altering the tractor frame.

### Power Transmission System

As shown in FIG. 5, the power transmission system can transfer rotational energy from a power take-off shaft of a riding mower to a rotor-stator assembly of a generator by routing torque through a belt-and-pulley path configured on a mower-deck envelope. Generally, the power transmission system can include a continuous belt that engages a power take-off (PTO) pulley interface and a generator pulley stack to define a primary drive ratio suitable for generator excitation over an engine speed range (e.g., 2,400-3,600 rpm). More specifically, the power transmission system includes a tensioner/activation arm that pivots to adjust belt tension and to enable torque coupling during operator engagement or disengagement. In particular, the power transmission system can maintain belt alignment and can limit slippage by positioning idler pulleys and belt guides along a wrap angle that achieves a predetermined contact area on each pulley. Additionally, the power transmission system can mount to a mounting assembly using hardware compatible with standard mower deck attachment points to support drop-in installation and removal without modification of a mower chassis. Alternatively, the power transmission system can support stationary operation or mobile operation by allowing the belt to remain tensioned during movement or to be slackened for transport across terrain. Thus, the power transmission system leverages an existing PTO by providing a non-invasive mechanical interface that couples and decouples quickly, which supports immediate reliability from frequent mower use and reduces transport complexity by taking advantage of the mobility of a standard lawn tractor.

### Power Take-Off Pulley Interface

As shown in FIG. 5 FIG. 5 FIG. 5, the power take-off (PTO) pulley interface 1 couples a riding lawn tractor PTO output to the power transmission system by accepting a continuous V-belt and by transferring rotary power to a generator pulley stack. In one implementation, the PTO pulley interface provides a V-belt pulley assembly fabricated from steel or cast aluminum and dimensioned to match common PTO sheaves and with a V-groove profile compatible with most common riding lawn tractors. More specifically, the PTO pulley interface secures to a generator input shaft via a tensioner arm designed to maintain torque transfer without slippage across a speed range between 2,000 and 3,600 RPM and a power level up to an exemplary 20-25 horsepower depending upon the lawn tractor's rated horsepower output. Additionally, the PTO pulley interface aligns with the generator pulley stack to establish a target belt wrap angle of 180 degrees or a belt position that is coplanar. The PTO pulley interface incorporates an idler and a tensioner/activation arm to permit selective belt engagement and disengagement. The simple standard PTO pulley interface enables rapid installation and removal by using a slip-fit hub and a single fastener capture so that an operator mounts or removes the power transmission system without modifying a tractor frame. Therefore, the PTO pulley interface leverages the riding mower's existing PTO systems and reduces deployment effort by enabling quick, repeatable coupling that reliably transmits power for mobile and stationary generation without requiring permanent tractor modifications.

### Generator Pulley Stack

As shown in FIG. 5 FIG. 6, the generator pulley stack can include one or more sheaves rigidly affixed to a generator input shaft of the rotor-stator assembly to receive mechanical power from the belt routed from the power take-off (PTO) pulley interface. More specifically, the generator pulley stack can establish a predetermined rotational speed ratio between a mower engine coupled through the PTO pulley interface and a generator rotor. In particular, the generator pulley stack can include a primary drive sheave and one or more auxiliary sheaves to accommodate the tensioner/activation arm and/or alternative belt paths for routing clearance and service access. Additionally, the generator pulley stack can comprise materials and geometries configured to withstand continuous torque transmission, for example using wear-resistant grooves and flank angles selected to minimize belt slip of the belt under variable electrical loading. Further, the generator pulley stack can accept different belt profiles and diameters to maintain compatibility with varied PTO pulley interface formats across riding mower platforms. The generator pulley stack can allow rapid drive engagement and disengagement when the tensioner/activation arm selectively loads the belt without modification to the power transmission system architecture. Thus, the generator pulley stack can provide a reliable mechanical interface that leverages the existing PTO pulley interface thereby addressing the lack of an integrated generator solution that leverages existing riding mower power take-off systems and the need for both a stationery and mobile power source that operates reliably from frequently used equipment.

### Belt

As shown in FIG. 5 and FIG. 6, the belt routes around the power take-off (PTO) pulley interface and the generator pulley stack to transmit rotational energy from a riding mower PTO spindle as an endless loop. More specifically, the belt can include a V-belt profile and a reinforced, heat-and oil-resistant elastomeric construction to deliver mechanical power with reduced slip and acceptable thermal rise. Additionally, the belt cooperates with the tensioner/activation arm to allow rapid engagement and disengagement by adjusting belt tension across fixed centers selected to match the pulley spacing. Thus, the belt enables the power transmission system to leverage an existing riding mower PTO without complex retrofits and with quick activation, which addresses the lack of an integrated PTO-based generator solution and supports immediate, mobile, reliable power availability.

### Tensioner/Activation Arm

As shown in FIG. 5 and FIG. 6, the tensioner/activation arm is a pivotally mounted arm that supports an idler pulley and that rotates about a fixed pivot axis of the power transmission system to selectively load the drive belt. More specifically, the tensioner/activation arm can translate an operator physical input into a radial displacement that mechanically moves the idler pulley against the belt to remove slack and to increase a wrap angle on a generator pulley stack, thereby enabling torque transfer from a power take-off (PTO) pulley interface to the generator pulley stack. In particular, the tensioner/activation arm can retract the idler pulley away from the belt during disengagement to introduce slack and to interrupt power transmission between the PTO pulley interface and the generator pulley stack. The tensioner/activation arm accepts manual actuation by a user via a handle to allow engagement and disengagement without additional electrical controls and/or wiring. The tensioner/activation arm incorporates a detent or over-center geometry to hold an engaged state and can include a return spring to bias a disengaged state for rapid transitions during mobile or stationary use. Therefore, the tensioner/activation arm provides a mechanical engaging and disengaging clutch function that enables an operator to couple and decouple the mower engine to the generator quickly and predictably, which addresses the need for an integrated PTO-based solution that remains simple to operate in the field and that supports immediate, reliable power availability without relying on a separate fueled generator.

### Power Distribution System

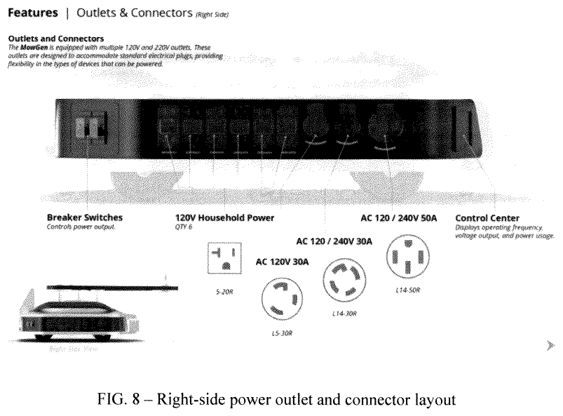

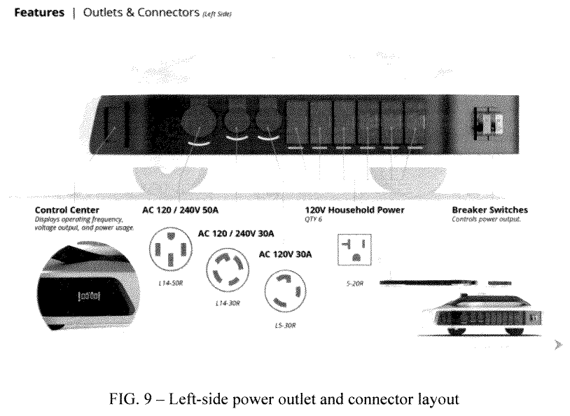

As shown in FIG. 8 and FIG. 9, the power distribution system can receive regulated output from the rotor-stator assembly and can route the output through an integrated electrical panel to a plurality of receptacles configured for different voltage and current ratings. More specifically, the power distribution system can energize 120/240-volt 30-amp twist-lock receptacles and 120/240-volt 50-amp connectors to support tools, appliances, and/or allow via an appropriate electrical connection cord, connection to a whole building power distribution panel. The power distribution system presents mirrored or duplicated outlet arrays on opposing faces of the housing to provide dual-side accessibility that accommodates connections from either side of the lawn tractor. Additionally, the power distribution system provides convenient accessibility regardless of MowGen orientation at a needed location. Thus, the power distribution system can solve interfacing challenges by providing standardized receptacles and a transfer-ready output, can reduce setup complexity via dual-side accessibility, and can enable reliable, frequent-use deployment by integrating power routing directly with the MowGen rather than relying on separate, infrequently used generator equipment.

### Breaker Panel

As shown in FIG. 8 and FIG. 9, the breaker panel mounts within the power distribution system and receives output from the rotor stator assembly via the voltage regulator to route protected branch circuits toward the outlet array and/or toward the transfer-switch interface. More specifically, the breaker panel can include miniature circuit breakers mounted on a DIN rail and rated for branch currents within a target range (e.g., 15-50 amperes) to segment loads associated with the 120 V duplex outlets, the 30 A twist-lock outlets, and the 50 A split-phase connectors. In particular, the breaker panel can wire each miniature circuit breaker in series with a dedicated outlet group and can provide individual line, neutral, and ground terminations that correspond to the receptacles of the outlet array to enable selective energization and isolation of equipment loads. Additionally, the breaker panel can present manual actuators that allow an operator to open and close each miniature circuit breaker and can incorporate a hinged or removable cover that shields live terminals while permitting service access to the DIN rail. Further, the breaker panel can drive a subset of the status indicator row to illuminate circuit-energized states above corresponding miniature circuit breakers and can route a dedicated feeder toward the transfer-switch interface to support direct connection to a building electrical panel or sub-panel. The breaker panel provides double-sided power-access to distribute identical protected circuits on opposing faces of the housing. Thus, the breaker panel can allocate, protect, and present generator power in code-compliant, user-configurable circuits that interface reliably with the transfer-switch interface and building infrastructure to address the difficulty of interfacing small engine power outputs with home or business electrical panels while enabling safe load management and overcurrent protection.

### Outlet Array

As shown in FIG. 8, and FIG. 9, the outlet array can integrate a plurality of electrical receptacles into the housing to present direct connection points for single-phase and split-phase loads while maintaining ergonomic access on the machine. Generally, the outlet array can include sixteen 120-volt AC duplex outlets that deliver standard household power and that equip each duplex with an individual rocker-style circuit breaker and a status indicator lamp to provide localized overload protection and operational feedback. More specifically, the outlet array can further include two 120/240-volt, 30-ampere twist-lock receptacles that conform to NEMA L5-30 or equivalent standards to supply higher-current portable equipment and/or temporary subpanel feeds. In particular, the outlet array can additionally provide two 120/240-volt, 50-ampere connectors that suit split-phase service and that maintain compatibility with manual transfer switches and/or high-capacity appliances under specifications such as NEMA 14-50. Also, the outlet array can distribute the receptacles on opposing faces of the housing to enable access from either side of a tractor and to permit flexible orientation during deployment in confined spaces. Thus, the outlet array can address difficulty interfacing small engine power with residential and commercial loads by presenting standardized connection formats across multiple current levels and by improving field usability through dual-sided access, which in turn supports connection to appliances, power tools, and whole-home transfer panels without additional external adapters.

### 120 Volt Duplex Outlets

As shown in FIG. 8 and FIG. 9, the 120 v duplex outlets can supply alternating current at a nominal 120 volts (v) with a continuous rating up to 20 amperes per receptacle and can conform to a NEMA 5-20R geometry to accept standard residential plugs. More specifically, the 120 v duplex outlets can arrange multiple banks on opposing faces of the housing to enable access from either side of the generator deck, and the 120 v duplex outlets can position status indicator lamps above each receptacle to convey power availability at a glance. In particular, the 120 v duplex outlets can incorporate an integral rocker-style circuit breaker at each duplex to provide per-outlet overcurrent protection and to allow selective energization and de-energization, and the 120 v duplex outlets can support direct connection of appliances, power tools, and extension cords without adapters. Thus, the 120 v duplex outlets can deliver immediate, standards-based power distribution at remote job sites or residences and can reduce. interface complexity by eliminating external switchgear for portable loads, thereby addressing difficulty interfacing small engine power outputs with typical end-use devices and enabling flexible load management.

### 30 Amperes Twist-Lock Outlets

Generally, 30 amperes (amp) twist-lock outlets can provide secure locking receptacles within the outlet array of the power distribution system to deliver higher-current utility loads. More specifically, 30-amp twist-lock outlets can conform to a power to external standard such as NEMA L 5-30R for 120-volt service and/or can implement a configuration that supports 120/240-volt, 30-amp service via appropriate conductor pairing and mating plug geometry. In particular, 30-amp twist-lock outlets can include a twist-to-lock mechanism that engages internal locking tabs after insertion and rotation to resist disconnection under vibration and cable tension. Furthermore, 30-amp twist-lock outlets can connect to generator windings of the rotor-stator assembly through the voltage regulator to supply stabilized voltage to heavy-duty tools, transfer switches, and/or subpanels. In one implementation, 30-amp twist-lock outlets can integrate weather-resistant bodies and gasketed flip covers that limit moisture ingress to an exemplary ingress protection rating between IP54 and IP67 for outdoor operation. In another implementation, 30-amp twist-lock outlets can mount on one side or on both sides of the housing as enabled by the double-sided power-access to facilitate user access regardless of tractor orientation. Thus, 30-amp twist-lock outlets can address field challenges by providing standardized high-current locking interfaces that maintain electrical continuity and streamline connection to residential or commercial transfer equipment for reliable backup power use.

### 50 Amperes Split-Phase Connectors

As shown in FIG. 8, and FIG. 9, the 50 amperes (amp) split-phase connectors can provide a NEMA 14-50R interface that delivers 120/240-volt split-phase output at a continuous current rating of up to 50-amp. More specifically, the 50-amp split-phase connectors can present a four-wire termination that allocates two hot conductors, one neutral conductor, and one equipment grounding conductor to satisfy standard North American whole-home backup practices. In one implementation, the 50-amp split-phase connectors can mount within a recessed, shielded region of the outlet array to reduce direct exposure to moisture and debris during outdoor operation. Additionally, the 50-amp split-phase connectors can incorporate environmental gasketing and strain-relief hardware to achieve an exemplary ingress protection level (e.g., IP54-IP65) while accommodating heavy-duty cables. In one embodiment, the 50-amp split-phase connectors can align with integrated overcurrent protection of the breaker panel so that the connectors selectively deliver split-phase power according to branch protection settings. In particular, the 50-amp split-phase connectors can mate with a manual transfer switch or a distribution panel via standard cords and adapters to energize multiple circuits such as HVAC, well pumps, refrigeration, and lighting loads. In another implementation, the 50-amp split-phase connectors can accept cable terminations sized for high-current operation (e.g., 6 AWG copper conductors) to limit conductor temperature rise under sustained loads. Additionally, the 50-amp split-phase connectors can position on opposite sides of the housing to support connection from either side of the riding mower when a user orients the MowGen near whole home or business breaker box. Further, the 50-amp split-phase connectors can include captive covers and mechanical latch geometry to maintain plug retention during vibration associated with mower PTO operation. Thus, the 50-amp split-phase connectors address difficulty interfacing small engine power outputs with residential panels by enabling a direct, code-compatible split-phase connection that simplifies safe transfer-switch integration and supports reliable whole-home backup power delivery.

### Transfer-Switch Interface

Generally, the transfer-switch interface can provide a covered, hard-wired terminal block and/or a set of cam-lock receptacles to couple generator output conductors to a building service-entrance transfer switch using standard residential and light commercial wiring methods. More specifically, the transfer-switch interface can accept single-phase 120/240 V conductors and can optionally route split-phase or three-phase conductors according to the generator output of the power distribution system. Additionally, the transfer-switch interface can enclose the terminal block within a weather-resistant housing to block environmental ingress during mobile and parked operation. The transfer-switch interface can mount on the housing at a perimeter region that remains accessible when MowGen mounts beneath a tractor chassis. The transfer-switch interface can mirror the receptacles and/or the terminal block on opposing sides of the enclosure to permit cable approach from either side of a driveway or structure. Thus, the transfer-switch interface can solve difficulty interfacing small engine power outputs with home or business electrical panels by enabling rapid, code-aligned, and misconnection-resistant connection to a transfer switch while supporting flexible access around the housing during deployment.

### Housing

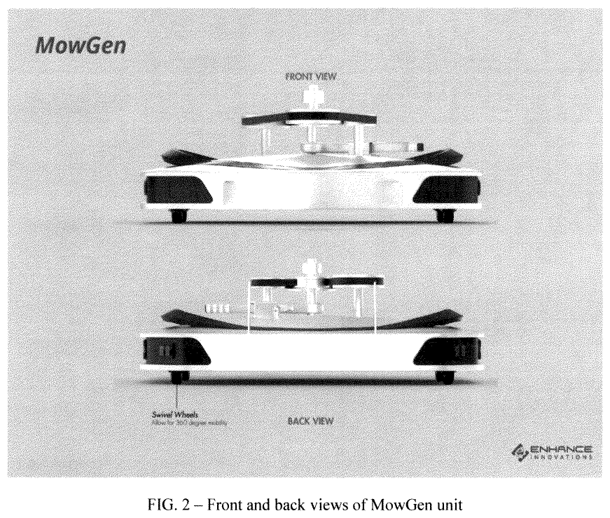

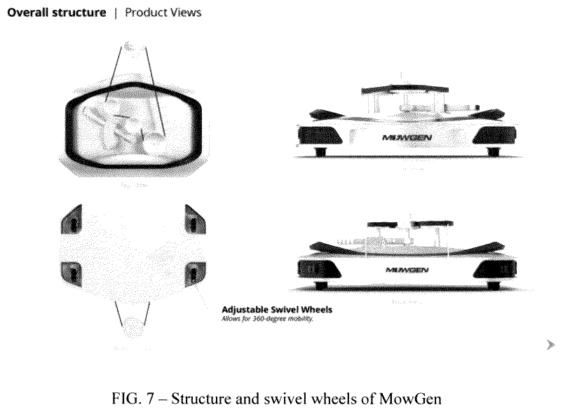

As shown in FIG. 2, FIG. 3, FIG. 5, FIG. 6, and FIG. 7, the housing can form a low-profile structural enclosure configured to contain the rotor-stator assembly, the power distribution system, and the power transmission system while fitting within an undercarriage envelope of a typical riding lawn tractor standard mower deck. More specifically, the housing can present radiused corners to reduce stress concentrations and to minimize snagging during installation or transport, and the housing can utilize powder-coated steel, aluminum, and/or polymer-resin construction to resist corrosion and environmental degradation. In one implementation, the housing can incorporate mounting flanges at a front center location and at rear corner peripheries, and the housing can dimension lateral apertures of the mounting flanges to align with stock deck-lift and stabilization rods and pins of standard riding mowers for drop-in compatibility without modification. Additionally, the housing integrates ergonomic handles on upper left and right top surfaces to facilitate manual maneuvering and installation. The housing also incorporates swivel casters in the base to enable rolling ingress and egress beneath a tractor and to provide ground support when detached. The housing provides recessed control and output panels on both left and right faces allowing convenient access to outlets regardless of site conditions. Thus, the housing can solve transport and positioning complexity via the handles and casters, can solve mower-integration difficulty via the aligned mounting flanges, and can support reliable PTO interfacing and continuous operation by maintaining enclosure rigidity, airflow, and protected, accessible power interfaces.

We claim:

1. A generator deck apparatus for a riding lawn tractor, comprising:
a low-profile housing sized to fit within an under-chassis envelope of the tractor;
a mounting assembly connected to the housing, the mounting assembly including mounting flanges dimensioned to couple with stock lift-link pins of the tractor so that the generator deck apparatus is installable in place of a conventional mower deck;
a rotor-stator assembly disposed within the housing for generating alternating current;
a power transmission system including:
a continuous V-belt configured to receive rotational input from a power-take-off (PTO) spindle of the tractor; and
at least one driven pulley fixed to an input shaft of the rotor-stator assembly;
a mechanical interface configured to selectively tension the V-belt to engage or disengage torque transfer; and
an integrated power distribution system electrically coupled to the rotor-stator assembly and providing external receptacle access for generated electrical power.

2. The generator deck apparatus of claim 1, wherein the mounting flanges comprise laterally elongated slots sized to accommodate dimensional variations among different mower models.

3. The generator deck apparatus of claim 1, wherein the mechanical interface comprises a pivoting tensioner/activation arm carrying an idler pulley that, when rotated, removes slack from the V-belt.

4. The generator deck apparatus of claim 1, wherein the integrated power distribution system comprises an outlet array including:
a plurality of 120 V duplex outlets;
at least one 120 V, 30 A twist-lock outlet; and
at least one 120/240 V, 50 A split-phase connector.

5. The generator deck apparatus of claim 1, wherein the integrated power distribution system further comprises:
a breaker panel comprising a plurality of miniature circuit breakers allocated to respective outlet groups; and
a status-indicator row comprising light-emitting diodes (LEDs) that illuminate when corresponding ones of the miniature circuit breakers are closed.

6. The generator deck apparatus of claim 1, further comprising of swivel casters mounted to the housing and dual maneuver handles, wherein the swivel casters and the maneuver handles are configured to enable the generator deck apparatus to be rolled and positioned when attaching to or detaching from the riding mower.

7. A method of supplying electrical power using a riding lawn tractor, the method comprising:
attaching the generator deck apparatus of claim 1 beneath the tractor via stock lift-link pins of the lawn tractor;
lowering the generator deck apparatus to a ground-supported position with a lift lever of the lawn tractor;
routing and installing a V-belt from a PTO spindle of the tractor to a driven pulley of the generator deck apparatus;
engaging the V-belt to couple engine torque to a rotor-stator assembly of the generator deck apparatus;
operating an engine of the tractor to rotate the rotor-stator assembly and generate electrical power; and
drawing electrical power from an integrated power distribution system of the generator deck apparatus to external loads.

8. The method of claim 7, wherein engaging the V-belt comprises manually actuating a pivoting tensioner/activation arm of the generator deck apparatus until a predetermined belt tension is achieved.

9. The method of claim 7, further comprising raising the generator deck apparatus with the provided lift mechanism of the tractor for transport between job sites while leaving the V-belt disengaged.

10. The method of claim 7, wherein engaging torque transfer comprises manually engaging a mechanical tensioner/activation arm.

11. The generator deck apparatus of claim 7, wherein the integrated transfer-switch interface further comprises cam-lock receptacles.

12. The generator deck apparatus of claim 7, wherein the integrated power distribution system is duplicated on both longitudinal faces of the housing to provide double-sided power access

13. The generator deck apparatus of claim 7, wherein structural components of the housing are formed from either sheet steel, polymer resin or aluminum alloys.

14. The generator deck apparatus of claim 7, wherein the mounting assembly employs quick-release couplings, and further comprising swivel casters and a maneuver handle, the generator deck employing quick-release couplings permitting tool-less attachment or removal.
